(19) United States
(12) Patent Application Publication
(10) Pub. No.: US 2005/0217572 A1
(43) Pub. Date: Oct. 6, 2005

(54) Ultraviolet particle coating systems and processes

(76) Inventors: Ming-Wan Young, Basking Ridge, NJ (US); Bainian Qian, Newark, NJ (US); Costas Gogos, Wyckoff, NJ (US); Rajesh Dave, Short Hills, NJ (US); Linjie Zhu, Kearny, NJ (US)

Correspondence Address: KAPLAN GILMAN GIBSON & DERNIER L.L.P., 900 ROUTE 9 NORTH, WOODBRIDGE, NJ, 07095, US

(21) Appl. No.: 11/094,842

(22) Filed: Mar. 30, 2005

Related U.S. Application Data
(60) Provisional application No. 60/557,479, filed on Mar. 30, 2004.

(51) Int. Cl. B05C 5/00

(52) U.S. Cl. 118/313

(57) ABSTRACT

Particle coating processes and systems employ UV curable materials to form tack-free surfaces rapidly. By applying UV curable compositions on well suspended particles a UV particle coating technology enables a scalable process of coating fine particles at desirable coating thicknesses with a wide spectrum of obtainable properties. Processes in accordance with the present invention decouple the particle suspension and film formation steps, enabling ample time to first deliver evenly the coating materials to the particle surfaces, followed by rapid polymerization/curing reaction induced by the UV light to rapidly create tack-free surfaces, thus preventing particles agglomeration while achieving uniform and thin-layer coating.

### CROSS-REFERENCE TO RELATED APPLICATIONS

This application claims the benefit of U.S. Provisional Patent Application Ser. No. 60/557,479, entitled “ULTRAVIOLET PARTICLE COATING PROCESSES,” filed Mar. 30, 2004, the entire disclosure of which is incorporated herein by reference.

### FIELD OF THE INVENTION

The present invention relates to particle coating and in particular to devices and methods for ultraviolet coating of particles.

### BACKGROUND

Conventional liquid spray particle coating processes are commonly known to be prone to agglomeration due to the prolonged period of time needed to convert coated liquid to a tack free solid, even when the uncoated particles can be well separated in the suspension stage. In addition, the common use of a solvent or nonsolvent in conventional particle coating processes poses environmental, health and cost concerns. Thus there is a need for a particle coating process that reduces or eliminates agglomeration. It would also be beneficial to the environment, cost effective and reduce health risks to provide a particle coating process that is solvent-free.

### SUMMARY OF THE INVENTION

Novel particle coating processes and systems in accordance with the present invention take advantages of the ability of UV-curable materials to form tack-free surfaces rapidly. By applying UV curable compositions on well suspended particles the present inventors have found that the UV particle coating technology enables a scalable process of coating fine particles at desirable coating thicknesses with a wide spectrum of obtainable properties. Processes in accordance with the present invention completely decouple the particle suspension and film formation steps, enabling ample time to first deliver evenly the coating materials to the particle surfaces, followed by rapid polymerization/curing reaction induced by the UV light to rapidly create tack-free surfaces, thus preventing particles agglomeration while achieving uniform and thin-layer coating. Solventless UV coating processes in accordance with the present invention are considered to be an environmental friendly process since they typically operate at room temperature with very high transfer efficiency. Unlike conventional coating technologies, no heating is required to either evaporate a carrier solvent or cross-link a coating. This is a significant advantage in the coating of heat-sensitive substrates. Final coating performance, such as barrier properties, solubility, permeability, flexibility, chemical resistance, hardness, and sensitivity to stimuli can also be readily tuned to appropriate needs by adjusting the UV chemistry and UV radiation exposure. This technology is readily adoptable to provide functional coatings in various applications including munitions constituents, chemicals, food, pharmaceutical and agricultural industrial sectors.

In accordance with at least one aspect of the present invention a process of coating particles is provided comprising essentially the steps of introducing a UV curable liquid onto a suspended particle, followed by UV curing. Essentially, after a selected amount of UV-curable liquid is coated on the particle surfaces, the coated UV liquid is converted to solid coatings when exposed to a UV source.

In at least one embodiment a process in accordance with the present invention is free or essentially free of solvent.

In accordance with at least one aspect a particle suspension step can be achieved by conventional dry particle coating devices such as but not limited to fluidized coaters, drum coaters, or tumbling coaters equipped with liquid spray capabilities. In one embodiment a system in accordance with the present invention employs vacuum applied in a closed system coater such as a drum or tumbling coater.

According to at least one aspect suspension media, depending on a specific application, include but are not limited to air, nitrogen, carbon dioxide or any other gases or combination thereof known to be appropriate to those having skill in the art. In one embodiment, non-oxygen containing media is preferred due to the potential of oxygen to inhibit UV polymerization reactions and safety considerations.

UV-curable materials contemplated by the present invention include but are not limited to free radical systems or ionic systems. UV liquids in accordance with the present invention typically consist of oligomers, photoinitiators, reactive diluents, and fillers or additives. In free radical systems the curable materials polymerize and cure only when exposed to UV radiation. Suitable UV curable monomers include aliphatic urethane acrylate, aromatic urethane acrylate, polyester acrylate, epoxy acrylate, ether acrylate and amine modified ether acrylate. Reactive diluents in accordance with the present invention include mono or multi-functional acrylates. Acceptable photo initiators include α-hydroxylketone, α-aminoketone, mono acyl phosphine and bis acyl phosphine.

In ionic systems, once initiated, polymerization and curing will advance even without exposure to UV radiation. Suitable cationic curable materials include monocycloaliphatic epoxides and biscycloaliphatic epoxides. Examples of suitable co-monomers are vinyl ethers. Suitable photo initiators include diaryliodonium salts and triarylsulfonium salts.

The wavelength of UV light employed is in the range of about 200 to about 400 nm.

### OBJECTS OF THE INVENTION

It is an object of the present invention to provide novel particle coating techniques employing a UV curing step.

It is a further object of the present invention to permit the coating of particles without the use of solvents.

It is another object of the present invention to provide a process for particle coating that reduces agglomeration.

It is a further object of the present invention to provide novel, versatile and cost effective processes for coating components with UV curable polymeric materials.

It is still a further object of the present invention to provide devices capable of coating particles in accordance with processes disclosed herein.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a system in accordance with at least one aspect of the present invention.

FIGS. 1A-1C depict mechanics of a process in accordance with at least one aspect of the present invention.

FIG. 2 is a flow diagram depicting a process in accordance with at least one aspect of the present invention.

FIGS. 3A-3D are scanning electron micrographs of particles prior to being subjected to a coating process according to Experiment II in accordance with at least one aspect of the present invention.

FIGS. 4A-4D are scanning electron micrographs of the particles of FIGS. 3A-3B after being subjected to a coating process according to Experiment II in accordance with at least one aspect of the present invention.

FIGS. 5A-5D are scanning electron micrographs of particles coated according to Experiment III in accordance with at least one aspect of the present invention.

FIG. 6A depicts Raman spectra of uncured and cured UV material.

FIG. 6B depicts Raman spectra of coated particles in accordance with Experiment III herein.

FIGS. 7A-7D are scanning electron micrographs of particles coated in accordance with Experiment IV in accordance with at least one aspect of the present invention.

FIG. 8 depicts Raman spectra of coated particles in accordance with Experiment IV herein.

FIGS. 9A-9D are scanning electron micrographs of particles coated in accordance with Experiment V in accordance with at least one aspect of the present invention.

FIG. 10 depicts Raman spectra of coated particles in accordance with Experiment V herein.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” in various places in the specification are not necessarily all referring to the same embodiment.

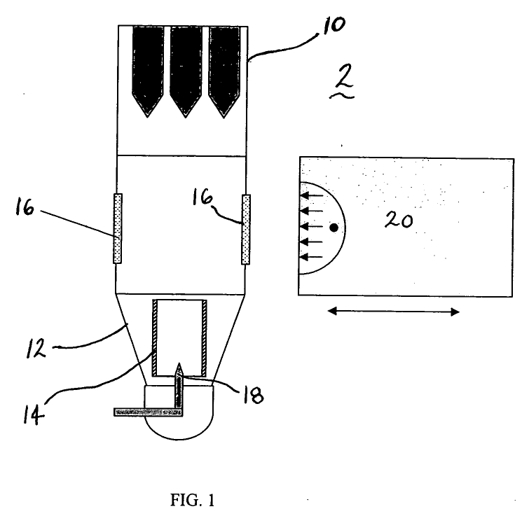

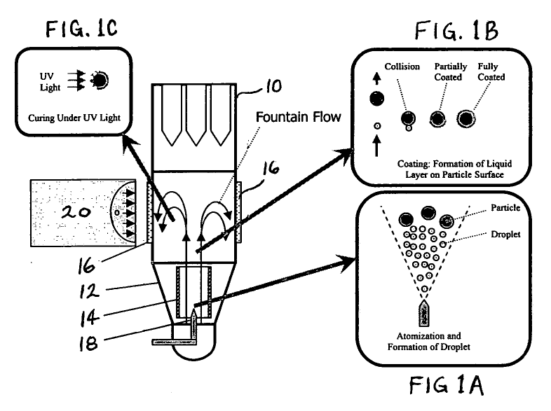

Now referring to FIG. 1 a system 2 in accordance with the present invention includes a coater such as but not limited to a fluidized bed coater 10, product vessel 12, wurster tube 14, window 16, nozzle 18 and UV light source 20. A variety of coaters may be employed for fluidization including but not limited to batch operating coaters such as a Glatt Mini fluidized bed with liquid spray (top or bottom) nozzle; rotating fluidized bed; magnetic assist impact coater; drum coater with or without mixing baffles and deflectors; and continuous coaters such as free fall coaters with or without the use of deflectors and spin coaters. Preferably, any coater employed is modified for UV light delivery by providing a quartz glass window. In a preferred embodiment the coater is a fluidized bed coater.

In an alternate embodiment, a second air flow (not shown) is introduced into the fluidization bed in order to clean the glass window during the coating process.

It will be apparent to those skilled in the art the UV light source 20 may be internal in the coater 10, externally attached to the coater 10 or not connected to the coater 10. In one embodiment as indicated by the arrow in FIG. 1 an external UV light source 20 is provided, preferably adapted to slide or roll toward and away from the coater 10 as needed. For example, the UV light source 20 may need to be moved away from the coater 10 when loading particles into the fluidized bed or unloading samples. The UV lamp 20 can be moved close to the glass window 16 for use during coating processing.

A process in accordance with the present invention includes suspending particles in a coater 10, feeding a UV curable liquid into the coater 10 and exposing the UV curable liquid to a UV light source for a selected period of time. Now referring to FIGS. 1-1C, coating of a UV-curable composition on a particulate surface in accordance with one embodiment of the present invention includes the steps of atomization of UV liquid through a spray nozzle to form droplets D in an environment containing particles P to be coated (FIG. 1A), wetting fluidized solid particulates P with UV liquid droplets D and formation of a liquid layer comprising droplets D which covers the surfaces of particles P (FIG. 1B) and rapid curing of UV liquid by exposure to a UV light 20 (FIG. 1C). The foregoing process may be conducted in a system such as system 2.

Alternatively, materials to be coated such as, but not limited to, RDX powders are premixed with UV curable powder in any conventional blender. The mixture is introduced into a coater and exposed to a UV light source. In a preferred embodiment, the blender is heated to about 100° C. to achieve uniform coating.

UV-Curing

UV curable materials employed in the novel processes may be selected from free radical systems or ionic systems. In free radical systems the UV-curable materials polymerize and cure only when exposed to UV radiation. In ionic systems, once initiated, polymerization and curing will advance even without exposure to UV radiation.

Monomers

As will be apparent to those having skill in the art when selecting monomers for a particular system important characteristics to consider include curing speed and viscosity. Optimally, curing speed is high and viscosity low. In addition, as will be apparent to those having skill in the art, properties of importance are adhesion which optimally is excellent, elasticity which should be at least good, hardness which should be fair to good, general barrier properties which should be excellent, and flexibility which should be good to excellent. Acceptable monomers include acrylates with multi functionalities (double bonds), i.e., more than 2 and preferably between 4-6. Suitable UV curable monomers in free radical systems include but are not limited to suitable acrylates such as aliphatic urethane acrylate, aromatic urethane acrylate, polyester acrylate, epoxy acrylate, ether acrylate and amine modified ether acrylate. Suitable commercially available monomers include Laromer® (BASF), Actilane® (Akzo Nobel); aromatic urethane acrylates including Actilane® 130, Actilane® 196, and Laromer® UA 9031V; aliphatic urethane acrylates including Actilane® 251 (Akzo Nobel), Laromer® LR 8987, Laromer® UA 9029V; epoxy acrylates including Actilane®300HV, Actilane® 340, Laromer® LR 9019 & LR 9023; polyester acrylates including Actilane® 500 series, Laromer® LR 8981, Laromer® PE 56F; and amine acrylates including Actilane® 765, Laromer® LR 8812, Laromer® LR 8889 and Laromer® LR 8869.

In addition to the monomers mentioned above, the following monomers can be polymerized by an ionic based photocatalyst: multi-functional vinyl ethers, multi-functional epoxides, hybrids of vinyl ether and epoxide ans cyclic monomers such as cyclic sulfides, cyclic ethers, cyclic amines and trioxane.

Photocatalysts (Liquids or Solids)

As will be apparent to the skilled artisan characteristics under consideration when selecting an appropriate photocatalyst or photoinitiator include solubility (preferably high), catalytic efficiency (preferably high), tendency toward poisoning by oxygen (preferably none to low), thermal stability (preferably high), toxicity (preferably low) and quantum yield (preferably high).

Examples of free radical based photocatalysts include α-hydroxyl ketone, monoacyl phosphine (MAPO), bis acyl phosphine (BAPO), and mixtures of α-hydroxyl ketone/BAPO, preferably in proportions ranging from about 5:95 to about 20:80 by weight. Suitable commercially available free radical based photocatalysts include Irgacure® 2959, Irgacure® 819, Irgacure® 2005 & 2010 & 2020 (Ciba), Lucirin® LR 8953, Lucirin® LR TPO (BASF), Darocure® 1173 and SR 1129 (Sartomer). Preferably, free radical based photocatalysts comprise less than about 10 parts, preferably between 1-3 parts by weight of a UV curable composition.

Examples of ionic based photocatalysts include iodonium salts such as diphenyliodium salts; sulfonium salts bearing at least one aromatic or other resonance stabilizing chromophore, such as triphenylsulfonium salts, trialkylsulfonium salts and dialkyophenacylsulfonium salts; and ferrocenium salts. Preferably, ionic based photocatalysts comprise less than about 10 parts, preferably between 1-3 parts by weight of a UV curable composition.

Reactive Diluents

As will be apparent to the skilled artisan characteristics under consideration when selecting an appropriate reactive diluent include viscosity (preferably low), reactivity (preferably medium to high) and performance enhancement (preferably high). The performance considerations are the same as those for monomers, i.e., adhesion which optimally is excellent, elasticity which should be at least good, hardness which should be fair to good, general barrier properties which should be excellent, and flexibility which should be good to excellent. Suitable commercially available reactive diluents include mono or multi-functional acrylates such as compositions of the Actilane® 400 series. Preferably, reactive diluents comprise less than about 30 parts, preferably less than about 10 parts by weight of a UV curable composition.

Preferably, the surface tack free time in either free radical or ionic systems ranges from a fraction of a second to minutes, most preferably less than about 10 seconds. Complete through cure time can range from a fraction of a second to minutes, most preferably less than 30 seconds. The coating thickness ranges from 1 to 1000 microns, preferably less than 5 microns. Optimum curing temperature ranges from about 20° C. to about 80° C., preferably about 20° C. Appropriate acceptable gas media include air, CO2 and N2, preferably CO2. Coatings made in accordance with the present invention exhibit good adhesion, cost-effectiveness, and a wide range of attainable properties.

The wavelength of UV light employed in both free radical and ionic systems in accordance with the present invention is preferably in the range of from about 200 nm to about 400 nm.

The UV particle coating methods of the present invention permit at least one thin layer of polymeric materials to be evenly coated onto selected particles, while particle agglomeration is kept at a minimum or entirely eliminated. The processes disclosed herein allow the tailoring of coating structures and thickness, which can be achieved by controlling numbers of spray/curing cycles of the same or different UV curable liquids.

The teachings of the present invention are applicable in a broad range of particle sizes. It will be apparent to those skilled in the art that particles ranging in size from about 200 nm to about 500 microns and larger can be coated in accordance with the teachings of the present invention. In one embodiment, methods employed in accordance with the present invention employ particles in the range of from about 10 microns to about 300 microns.

Those skilled in the art will appreciate variables in UV coating processes employing a fluidization bed can be grouped into three categories: fluidization parameters, spraying variables and curing variables. Table 1 summarizes these variables.

TABLE 1
Variables in UV Coating

| Category | Parameter | Note |
|---|---|---|
| Fluidization | Dimension of Fluidized Bed | These four parameters depend on |
| Parameters | Diameter of Wurster Tube | the type of fluidization bed used in |
| | Shape of Product Vessel | the coating process. |
| | Air Distributor Openings | |
| | Gap between Wurster Tube | Adjustable parameter, would affect |
| | and Air Screen | the fountain flow of particles. |
| | Fluidization Media | Air, Nitrogen or Carbon dioxide |
| | Fluidization Air Flow Rate | Adjustable parameter, would affect |
| | | the fluidization behavior |
| | Air Temperature | Adjustable parameter, would affect |
| | | the curing of UV-curable chemicals |
| | Particle Weight per Batch | Affect the fluidization performance |
| | Secondary Air Flow Rate* | Adjustable, and may affect the |
| | | fluidization behavior |
| | Filter Air Pressure | The air through the filter will clean |
| | Filtering interval | any particles sticking to the filter |
| | | and filter housing. |
| Atomization | Atomization Air Pressure | Determine the size of liquid droplet |
| Parameters | Nozzle Diameter | |
| | Pumping Rate | |
| | Amount of Liquid per Shot | Affect the fluidization behavior |
| | Spray model | Bottom spray or Top spray |
| Curing Parameters | Curing Time (UV Light | Affect the curing performance, and |
| | Exposure Time) Per shot | then the fluidization behavior |
| | Intensity of UV Light | |

*The secondary air flow rate is only a standard operating parameter in a fluidization bed employing a secondary air flow.

Those skilled in the art will also recognize coating processing also depends on the properties of particulates, UV chemicals, and the interaction between them, as listed in Table 2.

TABLE 2
Properties of Materials during Coating

| | |
|---|---|
| Particulate Properties | Size, Density, Shape, Surface Properties |
| UV Chemicals | Composition, Viscosity, Reaction Kinetics |
| Interfacial Properties between | Surface tension, wettability, etc. |
| Particulate and UV Chemicals | |

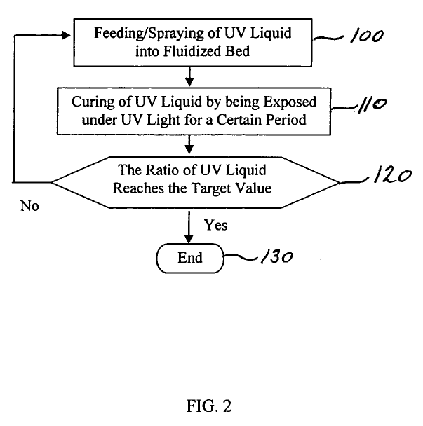

Over-deposition of UV-curable materials on a particle surface tends to raise the adhesive force between particles, which has the potential for instabilities in the fluidization process, namely defluidization or quenching, and some degree of agglomeration. In accordance with one embodiment, a multi-step feeding/spraying/curing method of coating particles employing UV-curable material as depicted in FIG. 2 provides stable operation to prevent over-deposition. In a preferred embodiment a process in accordance with the present invention includes feeding a UV curable liquid into a fluidized bed in step 100, curing the UV curable liquid by exposing the liquid to a UV light for a selected period of time in step 110, permitting the ratio of UV curable liquid to reach a target value in step 120 and stopping the feed of UV curable liquid once the target value is reached in step 130.

Experiments

A series of particle coating experiments employing a fluidized bed coater equipped with a UV light source were conducted. The equipment used in Experiments I-III was a Mini-Glatt, commercially available from Glatt Air Technology, equipped with a bottom spray modified to include a UV light source and a secondary air flow. Experiments IV and V employed a Glatt Microkit product vessel, which has a smaller diameter than the Mini-Glatt and a round corner at the air entrance, and equipped with a bottom spray, with a UV light source and secondary air flow. The particles employed in each experiment were potassium chloride (KCL) with an average diameter around 284 μm. Experiments were performed under nitrogen.

UV curable liquids available from Jodan Technology, Yorktown Heights, N.Y. were tested for various parameters as set forth in Table 3. Table 4 lists the description of each formulation. UV Intensity employed was 418 mW/cm^{2.}

TABLE 3

| | 25° C. | 25° C. | 60° C. | 60° C. | 80° C. | 80° C. |
|---|---|---|---|---|---|---|
| | Heat of | Cure | Heat of | Cure | Heat of | Cure |
| Sample | Reaction | time | Reaction | time | Reaction | time |
| ID | [J/g] | [s] | [J/g] | [s] | [J/g] | [s] |
| Formu- | −356.08 | 1.3 | −411.18 | 0.9 | −401.7 | 0.9 |
| lation | | | | | | |
| E98A | | | | | | |
| Formu- | −23.57 | 0.5 | −248.49 | 1.5 | −218.38 | 1.5 |
| lation | | | | | | |
| E98B | | | | | | |
| Formu- | −231.86 | 1.2 | −238.68 | 0.7 | −217.91 | 0.5 |
| lation | | | | | | |
| E98C-L | | | | | | |

TABLE 4

| Formulation* | Description |
|---|---|
| E98A | A mixture containing an epoxy mixture in amount of about 35-80% w/w, |
| | a polyol mixture in an amount of about 10-40% by weight, a |
| | photoinitiator (CAS # 108-32-7) in an amount of less than 6% w/w, |
| | propylene carbonate in an amount of less than 6% w/w and traces of |
| | epichlorohydrin. |
| E98B | A mixture containing an epoxy mixture in amount of about 35-80% w/w, |
| | a polyol mixture in an amount of about 10-40% by weight, a |
| | photoinitiator (CAS # 108-32-7) in an amount of less than 6% w/w, |
| | propylene carbonate in an amount of less than 6% w/w and traces of |
| | epichlorohydrin. |
| E98C | An acrylate urethane adhesive consisting of an acrylate oligomer in an |
| | amount greater than about 30% w/w, isobornyl acrylate (CAS # 5888-33- |
| | 5) in an amount greater than about 30% w/w and a photoinitiator in an |
| | amount less than about 5% w/w. |
| E98D | An acrylate adhesive consisting of an acrylated resin in an amount of |
| | about 50-80% w/w, methacrylate (high boiling) in an amount of about |
| | 20-40% w/w, a wetting agent in an amount of about 1-5% w/w, an |
| | adhesion promoter in an amount of about 1-5% w/w and photoinitiator in |
| | an amount of less than about 5% w/w. |
| E98C-L | A formulation developed based on E98C, with lower viscosity. |

*Product Number from Jordan Technology

In the experiments that follow, Formulation E98C and E98C-L were selected, considering the viscosity, curing time, and sensitivity to moisture. Experiments I-III used Formulation E98C, and Experiments IV-V used E98C-L.

Experiment I

Table 5 shows the operating conditions in the coater wherein the curing ratio of Formulation E98C was tested in a coating process. Table 6 lists the sampling procedure. The samples were tested at concentration of UV chemicals at 0.93% and 1.64% vol. Thermo-Gravimetric Analysis (TGA) was employed in the sample analysis. As seen in Table 7 it was observed at about half of the UV chemicals were cured, and elongation in curing time helps to increase the ratio of cured materials

TABLE 5
Operational Parameters

| | | | Gap Between | |
|---|---|---|---|---|
| Fluidization | Atomization | Pumping flow | Wurster tube | Weight of |
| Pressure | Pressure | rate | and air screen | Particle |
| 0.4 Bar | 0.6 Bar | 0.255 ml/min | 12 mm | 210 g |

| Air | UV Liquid | Secondary | UV Exposure |
|---|---|---|---|
| Temperature | per shot | Air Pressure | time Per shot |
| 25° C. | 0.273 ml | 20 psi | 180 s |

TABLE 6
Sampling during Coating

| Step Num. | Amount of | | | Concentration of |
|---|---|---|---|---|
| for | Added UV | UV Light | | UV chemicals |
| Feeding | Chemicals | Exposure Time | Sampling | (vol.) |
| 1 | 0.273 ml | 30 s + 30 s | | |
| 2 | 0.273 ml | 30 s + 30 s | | |
| 3 | 0.273 ml | 30 s + 30 s | | |
| 4 | 0.273 ml | 30 s + 30 s | Sample 1 | 0.93% |
| 5 | | 30 s + 30 s | Sample 2 | 0.93% |
| 6 | 0.273 ml | 30 s + 30 s | | |
| 7 | 0.273 ml | 30 s + 30 s | | |
| 8 | 0.273 ml | 30 s + 30 s | Sample 3 | 1.64% |

TABLE 7
Coating efficiency based on TGA Analysis

| | Weight | At | Wt. | Coating |
|---|---|---|---|---|
| Sample | Loss (%) | Temp | Change (%) | Efficiency |
| 1 | 0.02039 | 200 C. | 6.98 | |
| | 0.2923 | 500 C. | 100.00 | 47.9% |
| 2 | 0.02972 | 200 C. | 10.18 | |
| | 0.292 | 500 C. | 100.00 | 46.2% |
| 3 | 0.05273 | 200 C. | 9.97 | |
| | 0.5291 | 500 C. | 100.00 | 48.1% |
| 4 | 0.03383 | 200 C. | 6.00 | |
| | 0.5636 | 500 C. | 100.00 | 53.5% |

Experiment II

Table 8 lists the operating conditions in the process. Table 9 shows the sampling procedure. The UV chemical was Formulation E98C. The air screen was modified with a paper filter, in order to adjust the fluidization behavior.

TABLE 8
Operating conditions

| | | | Gap Between | |
|---|---|---|---|---|
| Fluidization | Atomization | Pumping | Wurster | Weight of |
| Pressure | Pressure | flow rate | tube and air screen | Particle |
| 0.66 Bar | 1.0 Bar | 0.2 cc/min | 12 mm | 230 g |

| Air | UV Liquid | Secondary | UV Exposure | Concentration |
|---|---|---|---|---|
| Temperature | per shot | Air Pressure | time Per shot | of UV liquid |
| 25° C. | 0.3 ml | 20 psi | 180 s | 1.4% vol. |

TABLE 9

| | Amount UV | UV light |
|---|---|---|
| Spray/Curing Step | Chemicals | exposure time (s) |
| 1 | 0.3 ml | 180 s |
| 2 | 0.3 ml | 180 s |
| 3 | 0.3 ml | 180 s |
| 4 | 0.3 ml | 180 s |
| 5 | 0.3 ml | 180 s |
| 6 | 0.3 ml | 180 s |
| 7 | | 360 s |

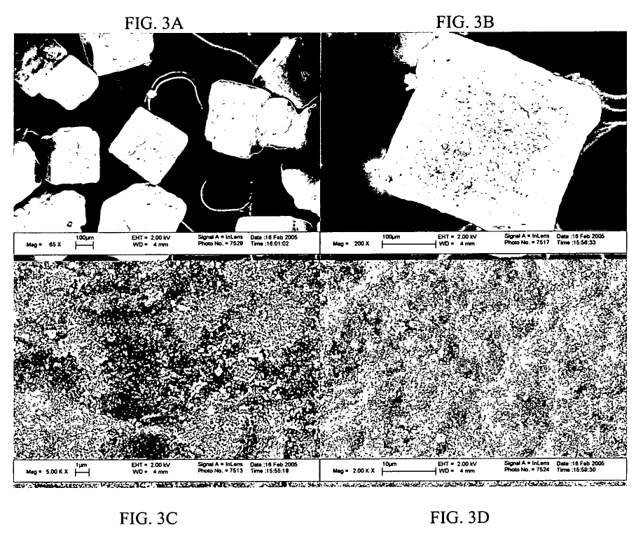

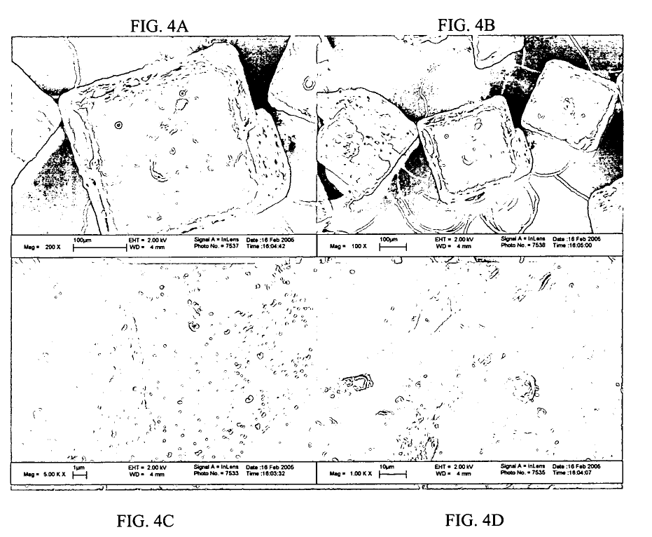

Now referring to FIGS. 3A-3D and 4A-4D Scanning Electron Microscopy (SEM) with EDX module was employed to determine the coating quality on the surfaces of particles. FIGS. 3A-3D show the SEM pictures of uncoated KCL particles at different magnitudes. It is seen that the particulate surfaces are not smooth. FIGS. 4A-4D show that after coating with UV chemicals, the surfaces of the particles appear much smoother due to the formation of a polymer layer.

Experiment III

Table 10 lists the operating conditions and Table 11 lists the sampling procedure. The air temperature was raised to 50° C. in this experiment, instead of 25° C. in Experiment II. The UV chemical amount per shot and the UV exposure time were also adjusted in order to shorten the total processing time.

TABLE 10
Operating conditions

| | | | Gap Between | |
|---|---|---|---|---|
| Fluidization | Atomization | Pumping | Wurster tube | Weight of |
| Pressure | Pressure | flow rate | and air screen | Particle |
| 0.66 Bar | 1.0 Bar | 0.2 cc/min | 12 mm | 230 g |

| Air | Secondary | Concentration |
|---|---|---|
| Temperature | Air Pressure | of UV liquid |
| 50° C. | 20 psi | 1.4% vol. |

TABLE 11

| Spray/ | Amount UV | UV light |
|---|---|---|
| Curing Step | Chemicals | exposure time (s) |
| 1 | 0.3 ml | 180 s |
| 2 | 0.3 ml | 180 s |
| 3 | 0.6 ml | 180 s |
| 4 | 0.3 ml | 360 s |
| 5 | 0.3 ml | 360 s |

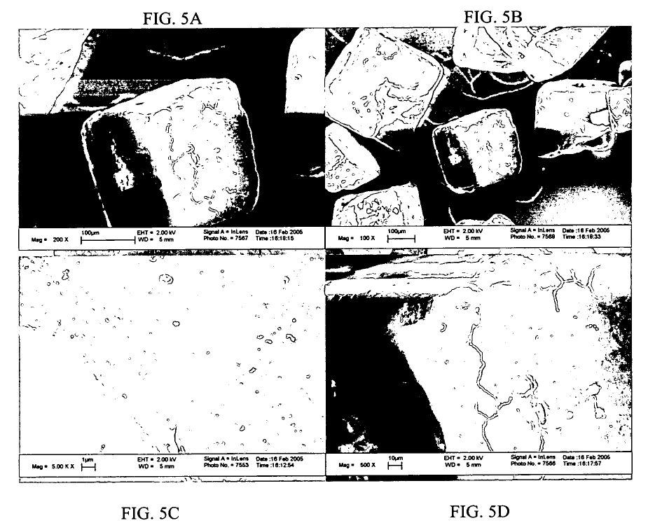

FIGS. 5A-5D show the SEM pictures of particles coated according to this experiment. The previously non-smooth KCL surface is smooth as a result of coverage with UV chemicals.

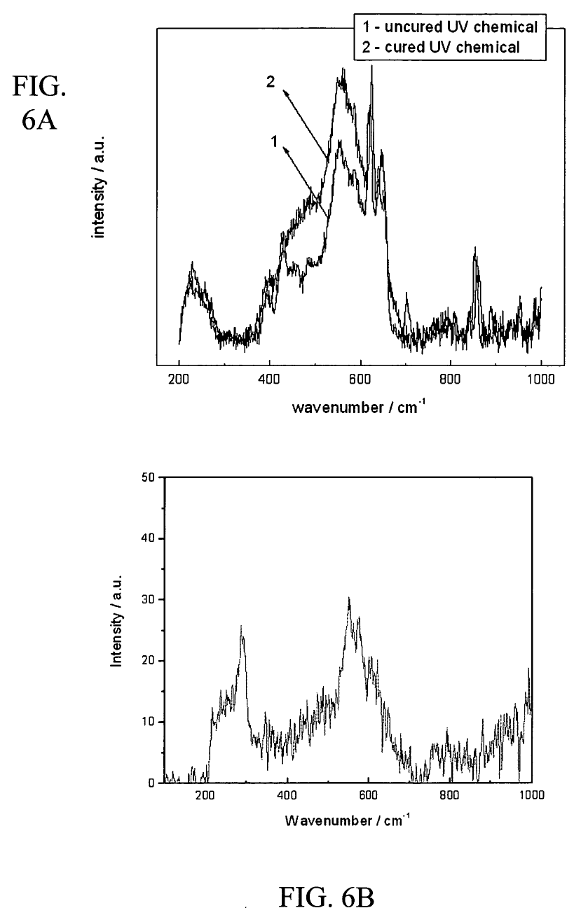

Confocal Raman Spectroscopy was used to check the curing of UV chemicals, as shown in FIG. 6A. FIG. 6A is spectra for cured and uncured UV curable material, prior to use in coating processes. The difference in the peak intensity around 570 cm⁻¹ and 610 cm⁻¹ indicates the curing of UV chemicals. As shown in FIG. 6A, in the uncured UV liquid, the intensity around 610 cm⁻¹ is much stronger than that around 570 cm⁻¹; after curing, the intensity around 610 cm⁻¹ almost equals to that of 570 cm⁻¹. That is, the peak intensity of 610 cm⁻¹ decreases during curing. FIG. 6B is spectra for the coated particles resulting in Experiment III. It is seen that the peak intensity around 610 cm⁻¹ is much weaker than that of 570 cm⁻¹, indicating a good curing of UV chemicals during the coating process.

Experiment IV

A Microkit product vessel was employed. Table 12 shows operating conditions and Table 13 the sampling procedure. Formulation E98C-L was employed as the UV curable liquid.

TABLE 12
Operating conditions

| | | | Gap | |
|---|---|---|---|---|
| | | | Between | |
| | | | Wurster | |
| Fluidization | Atomization | Pumping | tube and | Weight of |
| Pressure | Pressure | flow rate | air screen | Particle |
| 0.65 Bar | 1.0 Bar | 0.2 cc/min | 14 mm | 160 g |
| Air | | Secondary | Amount UV | Concentration |
| Temperature | | Air Pressure | Chemicals | of UV liquid |
| | | | per shot | |
| 50° C. | | 20 psi | 0.3 ml | 1.4% vol. |

TABLE 13

| Spray/Curing | Amount UV | UV light |
|---|---|---|
| Step | Chemicals | exposure time (s) |
| 1 | 0.3 ml | 180 s |
| 2 | 0.3 ml | 180 s |
| 3 | 0.3 ml | 180 s |
| 4 | 0.3 ml | 360 s |
| 5 | 0.3 ml | 360 s |
| 6 | 0.3 ml | 360 s |

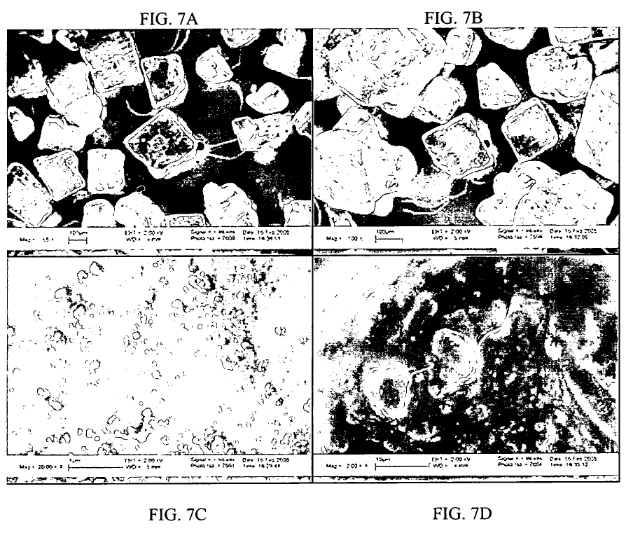

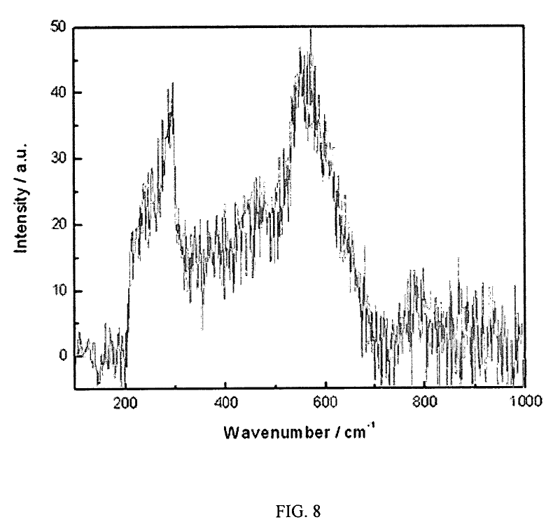

FIGS. 7A-7D show the SEM pictures of particles coated according to this experiment. The previously non-smooth KCL surface is smooth as a result of coverage with UV chemicals. Confocal Raman Spectroscopy was used to check the curing of UV chemicals, as shown in FIG. 8. The results from SEM and Raman indicate that the coated KCL particles are covered with UV chemicals, and the UV chemicals are cured.

Experiment V

The operating conditions were the same as those in Experiment IV except that the fluidization air pressure was increased gradually as coating proceeded in order to achieve stable fluidization, i.e., to counter the effect of any UV chemicals remaining uncured on the particle surface. Table 14 shows operating conditions and Table 15 the sampling procedure. Formulation E98C-L was employed as the UV curable liquid.

TABLE 14
Operating conditions

| | | | Gap | |
|---|---|---|---|---|
| | | | Between | |
| | | | Wurster | |
| Fluidization | Atomization | Pumping | tube and | Weight of |
| Pressure | Pressure | flow rate | air screen | Particle |
| See below | 1.0 Bar | 0.2 cc/min | 14 mm | 160 g |
| Air | | Secondary | Amount UV | Concentration |
| Temperature | | Air Pressure | Chemicals | of UV liquid |
| | | | per shot | |
| 50° C. | | 20 psi | 0.3 ml | 2.3% vol. |

TABLE 15

| Spray/Curing | Amount UV | UV light exposure | Fluidization |
|---|---|---|---|
| Step | Chemicals | time (s) | Pressure (Bar) |
| 1 | 0.3 ml | 180 s | 0.7 |
| 2 | 0.3 ml | 180 s | 0.7 |
| 3 | 0.3 ml | 180 s | 0.7 |
| 4 | 0.3 ml | 180 s | 0.75 |
| 5 | 0.3 ml | 180 s | 0.75 |
| 6 | 0.3 ml | 180 s | 0.8 |
| 7 | 0.3 ml | 180 s | 0.85 |

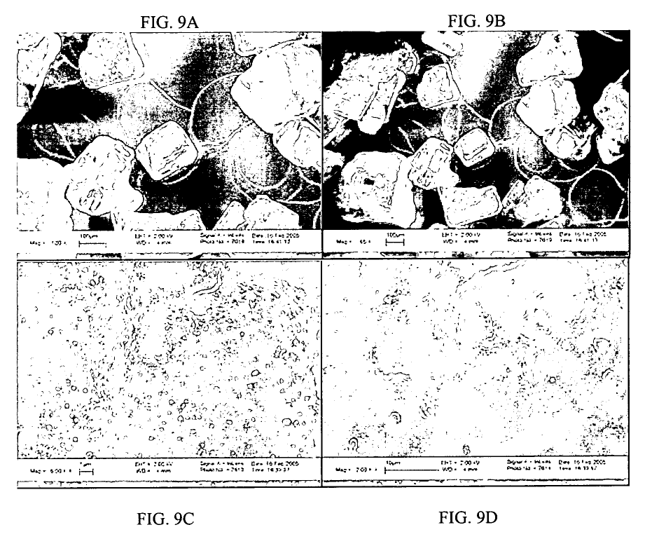

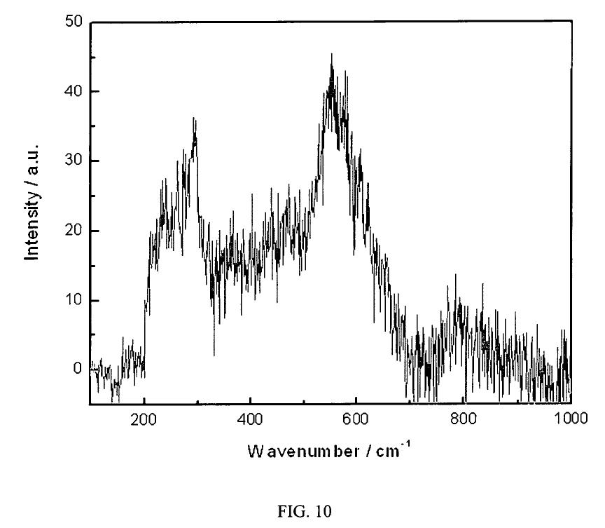

FIGS. 9A-9D show the SEM pictures of particles coated according to this experiment. The previously non-smooth KCL surface is smooth as a result of coverage with UV chemicals. Confocal Raman Spectroscopy was used to check the curing of UV chemicals, as shown in FIG. 10. The results from SEM and Raman indicate that the coated KCL samples are covered with UV chemicals, and the UV chemicals are cured.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of coating at least one particle comprising the steps of:
introducing at least one UV curable composition onto a suspended particle, and
curing said composition with UV irradiation.

2. The method according to claim 1 comprising suspending at least one particle in a particle coating device.

3. The method according to claim 2 said particle coating device selected from the group comprising fluidized coaters, drum coaters, and tumbling coaters.

4. The method according to claim 1 further comprising performing the introducing step in a suspension media selected from the group comprising air, nitrogen and carbon dioxide.

5. The method according to claim 4 the suspension media comprising non-oxygen containing media.

6. The method according to claim further comprising the step of applying a vacuum.

7. The method according to claim 1 wherein said method is performed at least in part in a coating apparatus modified for application of UV light by providing at least one quartz window in said coater.

8. The method according to claim 1 comprising atomizing at least one UV curable liquid composition through a spray nozzle, introducing said atomized liquid into an environment containing fluidized particles and wetting said fluidized solid particulates with said atomized liquid.

9. The method according to claim 1 comprising feeding said UV curable composition into a fluidized bed, exposing the composition to said UV light for a selected period of time, permitting a ratio of UV curable composition to reach a target value and stopping the feed of the UV curable composition once the target value is reached.

10. The method according to claim 1 said UV curable composition comprising a liquid.

11. The method according to claim 1 said UV curable composition selected from the group comprising a free radical system and an ionic system.

12. The method according to claim 1 said UV curable composition comprising at least one monomer and at least one photoinitiator.

13. The method according to claim 12, said at least one monomer comprising an acrylate.

14. The method according to claim 12 said photoinitiator selected from the group consisting of α-hydroxylketone, α-aminoketone, mono acyl phosphine and bis acyl phosphine.

15. The method according to claim 12 said monomer selected from the group consisting of multi-functional vinyl ethers, multi-functional epoxides, hybrids of vinyl ether and epoxide and cyclic monomers.

16. The method according to claim 12 said photoinitiator selected from the group consisting of iodonium salts, sulfonium salts bearing at least one aromatic or other resonance stabilizing chromophore, and ferrocenium salts.

17. The method according to claim 12 further comprising at least one reactive diluent.

18. A system adapted to coat particles comprising a coater having a product vessel, at least one UV light source positioned to irradiate particles in said product vessel with UV light, a port for introducing a UV curable composition into said product vessel and at least one air flow.

19. A system according to claim 18 said coater comprising a fluidizing coater.

20. A system according to claim 18 said coater selected from the group consisting of a fluidized bed, rotating fluidized bed, magnetic assist impact coater, drum coater, free fall coater and spin coaters.

21. A system according to claim 18, said UV light source positioned outside of said coater and said coater comprising a window to admit UV light from said UV light source.

22. A system according to claim 21, said window comprising quartz glass.

23. A method of coating at least one particle comprising the steps of:
contacting at least one particle to be coated with at least one UV curable composition and curing said composition with UV irradiation.

24. A method according to claim 23 comprising blending said at least one particle with at least one UV curable powder.

25. A method according to claim 24 comprising introducing a blended mixture of said at least one particle and at least one UV curable powder into a coating device.
